(19) United States
(12) Patent Application Publication
(10) Pub. No.: US 2012/0294579 A1
(43) Pub. Date: Nov. 22, 2012

(54) LIGHT GUIDE PLATE STRUCTURE

(76) Inventor: Ko-Ju Chen, Taoyuan (TW)

(21) Appl. No.: 13/179,559

(22) Filed: Jul. 10, 2011

(30) Foreign Application Priority Data
May 16, 2011 (TW) 100117042

(51) Int. Cl. G02B 6/10

(52) U.S. Cl. 385/130

(57) ABSTRACT

A light guide plate structure includes a light transmissive layer, which has a plurality of light guide points and/or brightness-improving holes used for altering a light route in the light transmissive layer. Each of the light guide points has a size within a range from 0.01 mm to 0.1 mm. The light guide points are distributed to form a plurality of regions corresponding to predetermined key locations. The distribution density of the light guide points in the light transmissive layer where the larger transmissive light intensity is received is smaller than that in the light transmissive layer where a relatively small transmissive light intensity is received. The distribution of the brightness-improving holes is in accordance with the brightness of transmissive light, where the sum of circumferences of all brightness-improving holes in a relatively dark region is greater than that in a relatively bright region.

### BACKGROUND OF THE INVENTION

1. Field of the Invention

The present invention is related to a light guide plate structure, and more particularly, to a light guide plate structure used in a thin key structure.

2. Description of the Prior Art

A light guide plate is commonly used to transmit a light from a light source to the surface of a key. According to the conventional technology, a distribution of plungers is arranged on the light guide plate for forming a uniform illumination. When the size of a screen dot is over 0.15 mm and the size of a computer number control process point is over 0.20 mm, however, the exceeding size invalidates the high uniformity of the distribution of plungers through optical design. Other designs of conventional light guide plates are detailed in the following.

USA Patent No.US2010/0282580A1 discloses a replaceable key structure, wherein the key structure includes a set of keys having projecting key tops, a replaceable front panel, and a replaceable light guide structure underneath the front panel. The light guide structure includes a plurality of strip structures corresponding to the front panel which also includes a plurality of strip structures. The protrusions or the pipes are formed at the fixed position of each of the stripped light guide structures for collecting light from the light source.

China Patent No.CN1909569A discloses a key light guide plate, wherein the light exit surface has several holes relative to the number and the position of keys. The surface where the light enters corresponds to the side light source and has a long groove with a protruded structure to the back of the light guide plate.

China Patent No.CN2886780Y discloses a key light guide plate, wherein the light guide plate includes several holes relative to the number and the position of keys, at least a reserving hole for reserving light from a side light source, and a plurality of plungers. The distribution density of the plungers increases away from the reserving holes. Furthermore, triangular holes can be disposed adjacent to the keys where a relatively high transmissive light intensity is received.

China Patent No.CN101162657A discloses a key light guide plate, wherein the light guide plate includes several holes relative to the number and the position of keys, and the wall of holes can be formed into a light-exit layer made of resin. The light-exit layer has a tilted surface which is adjusted by the cutting apparatus and the temperature.

Consequently, there is still a need for a novel light guide plate that assists uniform illumination of exit light.

### SUMMARY OF THE INVENTION

It is therefore one of the objectives of the present invention to provide a light guide plate structure used for uniform back-light to solve the bright spot problem.

A light guide plate structure according to an exemplary embodiment of the present invention is provided. The light guide plate structure includes a light transmissive layer. The light transmissive layer includes a plurality of light guide points used for altering a light route in the light transmissive layer, and each of the light guide points has a size within a range from 0.01 mm to 0.1 mm. The light guide points are distributed to form a plurality of regions corresponding to a plurality of predetermined key locations. A distribution density of the light guide points in the light transmissive layer where a relatively great transmissive light intensity is received is less than in the light transmissive layer where a relatively small transmissive light intensity is received. Additionally, the light transmissive layer includes a plurality of brightness-improving holes used for altering the light route in the light transmissive layer.

A light guide plate structure according to another exemplary embodiment of the present invention is provided. The light guide plate structure includes a light transmissive layer. The light transmissive layer includes a plurality of brightness-improving holes used for altering a light route in the light transmissive layer. A distribution of the brightness-improving holes is in accordance with a brightness of transmissive light. Furthermore, the sum of circumferences of the brightness-improving holes in a relatively dark region is greater than the sum of circumferences of the brightness-improving holes in a relatively bright region.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a planar diagram illustrating a light guide plate structure according to an exemplary embodiment of the present invention.

FIG. 2 is a cross-sectional diagram illustrating a light guide plate structure according to an exemplary embodiment of the present invention.

FIG. 3 is a cross-sectional diagram illustrating a light guide plate structure according to an exemplary embodiment of the present invention.

FIG. 4 is a cross-sectional diagram illustrating a light guide plate structure according to an exemplary embodiment of the present invention.

FIG. 5 is a manufacturing flow chart according to an exemplary embodiment of the present invention.

### DETAILED DESCRIPTION

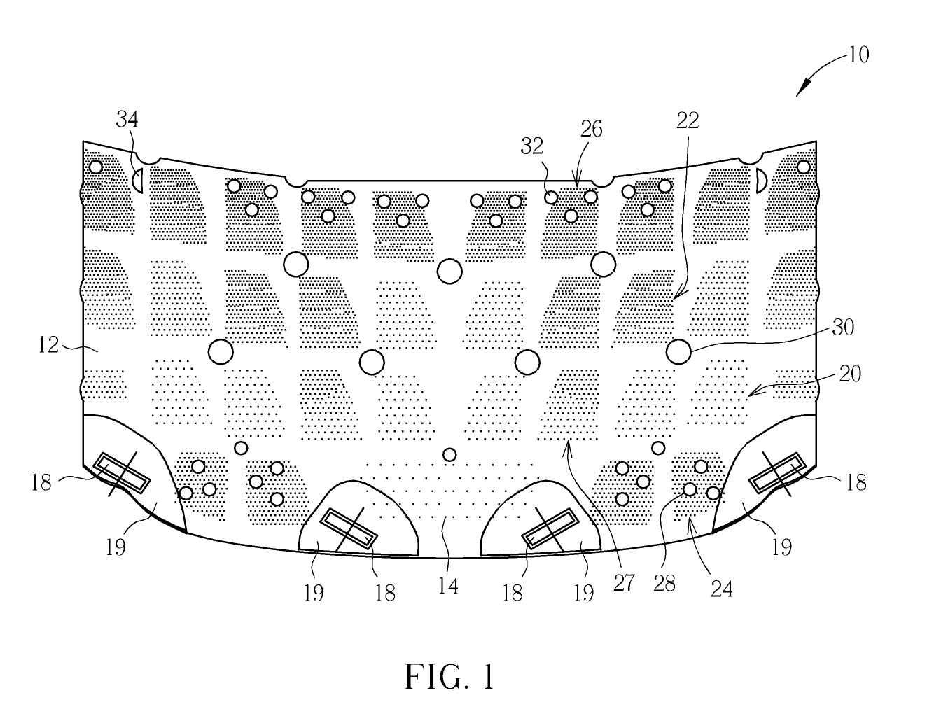

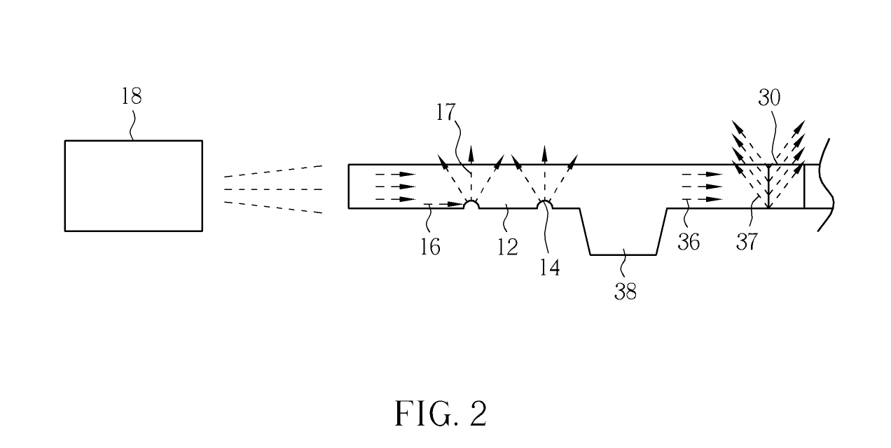

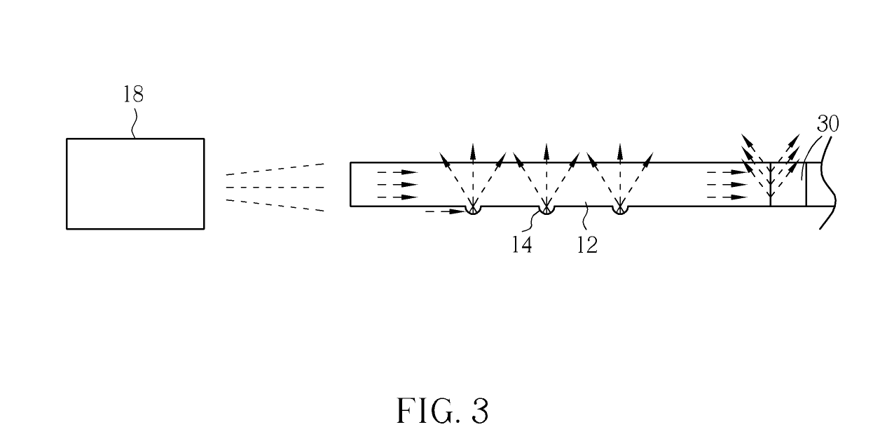

Please refer to FIG. 1 and FIG. 2. FIG. 1 is a planar diagram illustrating a light guide plate structure according to an exemplary embodiment of the present invention. FIG. 2 is a cross-sectional diagram illustrating a light guide plate structure according to an exemplary embodiment of the present invention. As shown in FIG. 1 and FIG. 2, a light guide plate structure 10 includes a light transmissive layer 12. The light transmissive layer 12 includes a plurality of light guide points 14 used for altering a light route 16 in the light transmissive layer 12: for example, the light guide points 14 are used for reflecting the light 16 to exit as the light 17. Each of the light guide points has a size within a range from 0.01 mm to 0.1 mm, and more specifically, as a surface of the light transmissive layer 12 where the light guide points 14 are located is a lateral surface, the size represents the cross-sectional size of the light guide point 14. These small light guide points 14 uniform backlight for preventing bright spots. Furthermore, the light guide points 14 may be in a convex shape or in a concave shape such as spherical, semi-spherical, cone-shaped, pyramidal or right pyramidal. A height of the convex light guide points 14 or a depth of the concave light guide points 14 preferably ranges from one tenth of a thickness of the light transmissive layer 12 to one third of the thickness of the light transmissive layer 12. In the exemplary embodiment illustrated in FIG. 2, the light guide points 14 are in a concave shape. Please refer to FIG. 3. FIG. 3 is a cross-sectional diagram illustrating a light guide plate structure according to an exemplary embodiment of the present invention. As shown in FIG. 3, the light guide points 14 are in a convex shape. The thickness of the light transmissive layer 12 may be as in the conventional design or according to individual requirements. The light guide points 14 could be disposed on any one of two surfaces of the light transmissive layer 12. For example, the light guide points 14 are disposed on the lower surface of the light transmissive layer 12 shown in FIG. 2 and FIG. 3, and it is also feasible to dispose these light guide points 14 on the upper surface of the light transmissive layer 12.

A material of the light transmissive layer 12 may include flexible and light transmissive material such as silicone, thermoplastic polyurethane (TPU) or UV glue. A material having a high light transmissive capability could improve the brightness and reduce the power consumption of the light source such as light emitting diode (LED). Moreover, the light guide plate structure 10 including the light transmissive layer 12 made of flexible and light transmissive material may overcome the problems of unpleasant tactile quality due to the rigid light guide plate made of polycarbonate (PC) and polymethylmethacrylate (PMMA).

The distribution of the light guide points 14 could be a sectional distribution: for example, the light guide points 14 are distributed to form a plurality of regions corresponding to a plurality of predetermined key locations. Additionally, a distribution density of the light guide points 14 is determined in accordance with a brightness of the light transmissive layer 12 without the light guide points 14. As the light of the light source enters the light transmissive layer 12, the light may be conveyed by the material of the light transmissive layer 12, and different transmissive light intensities are received at different locations of the light transmissive layer 12; in other words, the degree of brightness varies with the location. Consequently, for providing uniform illumination of exit light of the later formed light guide plate structure 10, it is preferred that the distribution density of the light guide points 14 in the light transmissive layer 12 where a relatively great transmissive light intensity is received is less than the distribution density of the light guide points 14 in the light transmissive layer 12 where a relatively small transmissive light intensity is received.

Please refer to FIG. 1 again. The regional and the distribution density of the light guide points 14 are illustrated clearly therein. A light source 18 such as an LED is disposed at a side of the light guide plate structure 10, and a light shielding layer 19 could be further disposed on the light source 18. Light guide point regions 20/22 both face the light source 18. The light guide point region 20 closer to the light source 18 has the larger transmissive light intensity; accordingly, the distribution density of the light guide points 14 in the light guide point region 20 is relatively small. Analogically, the light guide point region 22 farther from the light source 18 has the relatively small transmissive light intensity; accordingly, the distribution density of the light guide points 14 in the light guide point region 22 is relatively large. Moreover, although a light guide point region 24 is closer to the light source 18 than the light guide point region 20, the light guide point region 24 is located at a side of the light source 18; accordingly, the transmissive light intensity of the light guide point region 24 is lighter than that of the light guide point region 20, and the distribution density of the light guide points 14 in the light guide point region 24 is more than in the light guide point region 20. Furthermore, the light guide point region 26 is so far away from the light source 18, and the transmissive light intensity is particularly light in this region; therefore the distribution density of the light guide points 14 in the light guide point region 26 may be much higher. It can be appreciated that, even in the same light guide point region, the distribution density of the light guide points 14 could still be adjusted depending on the received transmissive light intensity. In other words, the distribution density of the light guide points 14 may be different in the same light guide point region, as shown in the light guide point region 27.

In addition, the light guide plate structure of the present invention may be applied in a direct-lighting backlight module or an edge-lighting backlight module.

The light transmissive layer 12 further includes a plurality of brightness-improving holes such as holes 28, 30, 32, 34 which may be manufactured through a punching process and accordingly named ‘punching holes’, as shown in FIG. 1 and FIG. 2. The brightness-improving hole 30 is used for altering the light route 36 in the light transmissive layer 12 by reflection and/or refraction. Afterwards, light 37 may emit from the wall of the brightness-improving hole 30 to enhance the brightness of the backlight at the brightness-improving hole 30 and its adjacent area. The size of the brightness-improving holes preferably range from 0.5 mm to 4.0 mm, and the configuration may be a geometric shape such as a circular hole, half-moon hole, triangular hole or tetragonal hole. A distribution and the size of the brightness-improving holes are in accordance with a brightness of transmissive light, rather than corresponding to the predetermined key locations and the size of the keys. The sum of circumferences of the brightness-improving holes in a relatively dark region is preferably greater than the sum of circumferences of the brightness-improving holes in a relatively bright region. In other words, the brightness-improving holes (the punching holes) are used to reflect and/or refract the light supposed to penetrate through the cutting region for improving the brightness.

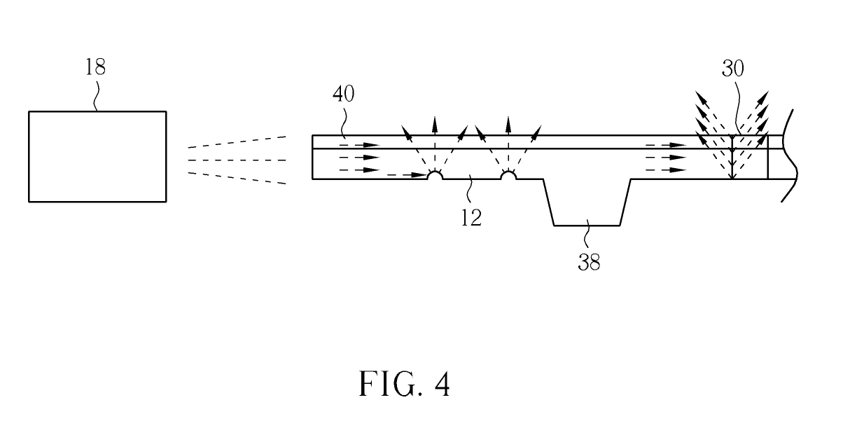

As the light guide plate structure according to the present invention is applied in the key structure, if the key structure includes a metal dome, the light transmissive layer may further include at least a plunger used for conveying a compressive pressure of a user to the later formed metal dome of the key. A plunger 38 is illustrated in FIG. 2 and FIG. 4, respectively. The plunger 38 may have a geometric shape. Furthermore, the light guide points 14 and the plunger 38 are disposed on the same surface/the different surfaces of the light transmissive layer 12.

The light guide plate structure according to the present invention may further include a transparent thin film combined with the light transmissive layer for sustaining the light transmissive layer. Moreover, as the transmissive layer includes the brightness-improving holes, the brightness-improving holes are further disposed to penetrate through the transparent thin film. FIG. 4 is a cross-sectional diagram illustrating a light guide plate structure according to an exemplary embodiment of the present invention. As shown in FIG. 4, the light guide plate structure further includes a transparent thin film 40. The transparent thin film 40 preferably has high optical transparency.

In another exemplary embodiment of the present invention, the disposition of a plurality of brightness-improving holes in the light transmissive layer of the light guide plate structure is unique. More specifically, in order to provide uniform illumination, a distribution of the brightness-improving holes are in accordance with a brightness of transmissive light, and the sum of circumferences of the brightness-improving holes in a relatively dark region is preferably greater than that in a relatively bright region. Additionally, a material of the light transmissive layer may include flexible and light transmissive material. A transparent thin film is further combined to the light transmissive layer for sustaining the light transmissive layer. The light transmissive layer may further include at least a plunger used for conveying a compressive pressure of a user to the later formed metal dome of the key.

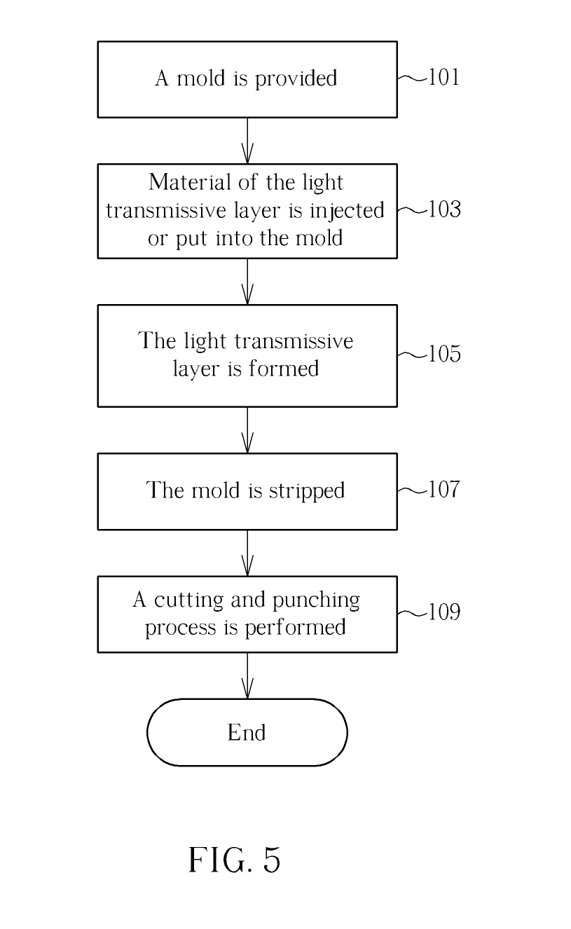

The light transmissive layer may be formed through a molding process such as an injection molding process or a compression molding process. FIG. 5 is a manufacturing flow chart according to an exemplary embodiment of the present invention. It is feasible to form the light guide points and/or at least a plunger on the light transmissive layer simultaneously through the molding process. At first, as shown in step 101, a mold is provided, and as shown in step 103, the material of the light transmissive layer is injected or put into the mold. As shown in step 105, the light transmissive layer is formed. The mold may include the shapes of the light guide points and/or the plunger as well; accordingly, the light guide points and/or the plunger could be formed at the same time as the light transmissive layer is formed. For the light transmissive layer having the transparent thin film disposed for sustainability, the combination of the transparent thin film and the light transmissive layer may be achieved by forming a composite of the transparent thin film and the light transmissive layer in the mold, or using a glue to fasten the transparent thin film and the light transmissive layer, but is not limited thereto. The mold is then stripped as shown in step 107. Subsequently, as shown in step 109, a cutting and punching process is performed to complete the fabrication of the light guide plate structures having separate configurations. As the mold is used to form a single light transmissive layer, the step 109 including the cutting and punching processes may be omitted. The brightness-improving holes could be formed through the cutting and punching processes individually/simultaneously at step 109, or through a molding process simultaneously at step 105.

The light guide points may be formed through another method by means of a mask and etching process. The mask having the pattern of the light guide points is formed to cover a surface of the light transmissive layer. Subsequently, the etching process is performed to remove a portion of the light transmissive layer not covered by the mask, and the fabrication of the light guide points is thereby completed. For example, if the exposed light transmissive layer, i.e. a portion of the light transmissive layer not covered by the mask, is predetermined to form the light guide points thereon, the light guide points will be in a concave shape after the etching process. In another aspect, if the covered light transmissive layer, i.e. a portion of the light transmissive layer covered by the mask, is predetermined to form the light guide points thereon, the light guide points will be in a convex shape after the etching process. The utilization of the mask and the etching process validates the formation of light guide points having small size as required in the present invention. Furthermore, the brightness-improving holes could be formed through a cutting and punching process simultaneously, or through an etching process.

Those skilled in the art will readily observe that numerous modifications and alterations of the device and method may be made while retaining the teachings of the invention.

What is claimed is:

1. A light guide plate structure, comprising:
a light transmissive layer, comprising:
a plurality of light guide points used for altering a light route in the light transmissive layer, wherein each of the light guide points has a size within a range from 0.01 mm to 0.1 mm, the light guide points are distributed to form a plurality of regions corresponding to a plurality of predetermined key locations, and a distribution density of the light guide points in the light transmissive layer where a relatively great transmissive light intensity is received is less than a distribution density of the light guide points in the light transmissive layer where a relatively small transmissive light intensity is received; and
a plurality of brightness-improving holes used for altering the light route in the light transmissive layer.

2. The light guide plate structure according to claim 1, wherein the light transmissive layer further comprises at least a plunger, and the plunger is used for conveying a compressive pressure of a user to a metal dome of a key.

3. The light guide plate structure according to claim 2, wherein the light guide points are respectively in a convex shape or in a concave shape.

4. The light guide plate structure according to claim 3, wherein a height of the convex light guide points or a depth of the concave light guide points substantially ranges from one tenth of a thickness of the light transmissive layer to one third of the thickness of the light transmissive layer.

5. The light guide plate structure according to claim 2, wherein the light guide points and the plunger are disposed on the same surface of the light transmissive layer.

6. The light guide plate structure according to claim 5, wherein the light guide points are respectively in a convex shape or in a concave shape.

7. The light guide plate structure according to claim 6, wherein a height of the convex light guide points or a depth of the concave light guide points substantially ranges from one tenth of a thickness of the light transmissive layer to one third of the thickness of the light transmissive layer.

8. The light guide plate structure according to claim 2, wherein the light guide points and the plunger are disposed on different surfaces of the light transmissive layer.

9. The light guide plate structure according to claim 8, wherein the light guide points are respectively in a convex shape or in a concave shape.

10. The light guide plate structure according to claim 9, wherein a height of the convex light guide points or a depth of the concave light guide points substantially ranges from one tenth of a thickness of the light transmissive layer to one third of the thickness of the light transmissive layer.

11. The light guide plate structure according to claim 1, wherein the light guide points are respectively in a convex shape or in a concave shape.

12. The light guide plate structure according to claim 11, wherein a height of the convex light guide points or a depth of the concave light guide points substantially ranges from one tenth of a thickness of the light transmissive layer to one third of the thickness of the light transmissive layer.

13. The light guide plate structure according to claim 1, wherein a material of the light transmissive layer comprises a flexible and light transmissive material.

14. The light guide plate structure according to claim 1, further comprising:
a transparent thin film combined with the light transmissive layer for sustaining the light transmissive layer, wherein the brightness-improving holes penetrate the transparent thin film.

15. The light guide plate structure according to claim 14, wherein a distribution of the brightness-improving holes is in accordance with a brightness of transmissive light, and the sum of circumferences of the brightness-improving holes in a relatively dark region is greater than the sum of circumferences of the brightness-improving holes in a relatively bright region.

16. The light guide plate structure according to claim 1, wherein a distribution of the brightness-improving holes is in accordance with a brightness of transmissive light, and the sum of circumferences of the brightness-improving holes in a relatively dark region is greater than the sum of circumferences of the brightness-improving holes in a relatively bright region.

17. A light guide plate structure, comprising
a light transmissive layer comprising a plurality of brightness-improving holes used for altering a light route in the light transmissive layer, wherein the sum of circumferences of the brightness-improving holes in a relatively dark region is greater than the sum of circumferences of the brightness-improving holes in a relatively bright region.

18. The light guide plate structure according to claim 17, wherein a material of the light transmissive layer comprises a flexible and light transmissive material.

19. The light guide plate structure according to claim 17, further comprising:
a transparent thin film combined with the light transmissive layer for sustaining the light transmissive layer, wherein the brightness-improving holes penetrate the transparent thin film.

20. The light guide plate structure according to claim 19, wherein the light transmissive layer further comprises at least a plunger, and the plunger is used for conveying a compressive pressure of a user to a metal dome of a key.

21. The light guide plate structure according to claim 17, wherein the light transmissive layer further comprises at least a plunger, and the plunger is used for conveying a compressive pressure of a user to a metal dome of a key.
